(19) United States
(12) Patent Application Publication
(10) Pub. No.: US 2026/0337357 A1
(43) Pub. Date: Oct. 29, 2026

(54) BLOWING AGENTS FOR FOAMED POLYMER APPLICATIONS

(71) Applicant: Solugen, Inc., Houston, TX (US)

(72) Inventors: Amit Desai, Sugar Land, TX (US); Jun Su An, Houston, TX (US)

(73) Assignee: Solugen, Inc., Houston, TX (US)

(21) Appl. No.: 19/101,602

(22) PCT Filed: Aug. 9, 2023
(86) PCT No.: PCT/US2023/071961

§ 371 Date: Feb. 6, 2025

Related U.S. Application Data
(60) Provisional application No. 63/370,820, filed on Aug. 9, 2022.
(60) Provisional application No. 63/514,050, filed on Jul. 17, 2023.

(51) Int. Cl. C08J 9/08; C08J 5/18

(52) U.S. Cl. CPC C08J 9/08; C08J 5/18; C08J 2201/03; C08J 2203/02; C08J 2203/184; C08J 2203/20; C08J 2323/06; C08J 2323/08; C08J 2323/12; C08J 2325/06

(57) ABSTRACT

A blowing agent composition comprising an oxidation product of one or more sugars and an optional second blowing agent. A foamed polymer composition comprising a polymer and a blowing agent comprising an oxidation product of one or more sugars and an optional second blowing agent. A method comprising forming a mixture comprising a blowing agent, an optional second blowing agent and a polymer and extruding the mixture to form a foamed polymer wherein the blowing agent comprises an oxidation product of one or more sugars. A method of making a foamed polymeric material comprising extruding a polymeric material and a blowing agent wherein the blowing agent comprises the oxidation product of one or more sugars.

### CROSS-REFERENCE TO RELATED APPLICATIONS

This application claims priority to U.S. Provisional Application No. 63/370,820 filed Aug. 9, 2022 and entitled “Blowing Agents for Foamed Polymer Applications,” and also claims priority to U.S. Provisional Application No. 63/514,050 filed Jul. 17, 2023 and entitled “Blowing Agents for Foamed Polymer Applications,” each of which is hereby incorporated herein by reference in its entirety for all purposes.

### TECHNICAL FIELD

The present disclosure relates generally to the production of foamed polymers. More particularly, this disclosure relates to oxidized sugars as multifunctional additives which can be utilized for example as blowing agents.

### BACKGROUND

Polymeric foams are widely used in different fields due to their lower density, reduced thermal conductivity, high-energy absorption capacity, and excellent strength-to-weight ratio. Foams are routinely used in applications such as transportation, bedding, carpet underlay, textile, toys, sport instruments, insulation appliances, and construction, biomedical, and automotive.

A polymer foam is basically a polymer-and-gas mixture, which gives the material a microcellular structure. A polymer foam having a closed cell structure is characterized by gas pores that are roughly spherical and separated from each other by the polymer matrix, then this type is called closed cell structure. A polymer foam having an open cell structure are characterized by pores that are interconnected to each other to some extent which provides passage of fluid through the foam. The compositions that are used in foam formation are categorized as either chemical blowing agents or physical blowing agents. Chemical blowing agents are chemicals that take part in a reaction or decompose, giving off a gas in the process. Physical blowing agents are gases that do not react chemically in the foaming process and are therefore inert to the polymer forming the matrix.

Some blowing agents, such as isocyanates and chlorofluorocarbons, face regulatory pressures due to their adverse effects on human health and the environment. Additionally, certain chemical blowing agents (e.g., isocyanates), leave a residue in the foams, which is considered toxic for some applications (e.g., medical, food-contact). Additionally, it would also be desirable to have blowing agents from bio-based feedstock instead of petroleum-based feedstocks for sustainability reasons.

### BRIEF DESCRIPTION OF THE DRAWINGS

For a detailed description of the aspects of the disclosed processes and systems, reference will now be made to the accompanying drawings in which:

FIG. 1 is a photograph of a foamed potassium glucarate sample.

FIG. 2 is a digital representation of a photograph of a sample of polylactic acid with calcium glucarate foamed in a single screw extruder.

FIG. 3 is a graph of the weight percent (normalized to initial weight) and heat flow of a sample of potassium glucarate as a function of temperature.

FIG. 4 is a graph of the weight percent (normalized to initial weight) of a sample of potassium glucarate as a function of time at fixed temperatures as labeled in the graph.

FIG. 5 is a graph of the weight percent (normalized to initial weight) of a sample of potassium glucarate (less than 1 mg) as a function of time at fixed temperatures as labeled in the graph. The inset images in the graph are digital representations of photographs of the sample at the end of the thermal treatment.

FIG. 6 is a graph of the weight percent (normalized to initial weight) of a sample of potassium glucarate (less than 1 mg) as a function of time at various fixed temperatures as labeled in the graph.

FIG. 7 is a graph of the weight percent (normalized to initial weight) and heat flow of a sample of sodium gluconate as a function of temperature.

FIG. 8 is a graph of the weight percent (normalized to initial weight) of a sample of sodium gluconate as a function of time at various fixed temperatures as labeled in the graph.

FIG. 9 is a graph of the weight percent (normalized to initial weight) and heat flow of a sample of potassium gluconate as a function of temperature.

FIG. 10 is a graph of the weight percent (normalized to initial weight) of a sample of potassium gluconate as a function of time at various fixed temperatures as labeled in the graph.

FIG. 11 is a graph of the weight percent (normalized to initial weight) and heat flow of a sample of calcium glucarate as a function of temperature.

FIG. 12 is a graph of the extruded foam density (in g/cc) of different low-density polyethylene (LDPE) foam samples.

FIG. 13 is a graph of the extruded foam density (in g/cc) of different high melt strength polypropylene (HMSPP) foams.

FIG. 14 is a graph of the extruded foam density (in g/cc) of different ethylene vinyl acetate foams.

FIG. 15 is a graph of the extruded foam density (in g/cc) for a HMSPP prepared with the indicated amounts of a chemical blowing agent and talc.

FIG. 16 is a graph of the tensile strength and % elongation at break for extruded LDPE films.

### SUMMARY

Disclosed herein is a blowing agent composition comprising an oxidation product of one or more sugars and an optional second blowing agent.

Also disclosed herein is a foamed polymer composition comprising a polymer and a blowing agent comprising an oxidation product of one or more sugars and an optional second blowing agent.

Also disclosed herein is a method comprising forming a mixture comprising a blowing agent, an optional second blowing agent and a polymer and extruding the mixture to form a foamed polymer wherein the blowing agent comprises an oxidation product of one or more sugars.

Also disclosed herein is a method of making a foamed polymeric material comprising extruding a polymeric material and a blowing agent wherein the blowing agent comprises an oxidation product of one or more sugars.

### DETAILED DESCRIPTION

In one or more aspects, disclosed herein is a blowing agent prepared from one or more renewable resources and termed a “bio-based blowing agent” or BBA. Also disclosed herein are compositions and methods for producing foamed polymer materials utilizing a bio-based blowing agent of the type disclosed herein.

In one or more aspects, the BBA comprises an oxidation product of one or more sugars. In an aspect, the oxidation product of one or more sugars comprises aldonic acid, uronic acid, aldaric acid, or a combination thereof and a counter cation. For example, the oxidation product of one or more sugars may be a mixture of aldaric, uronic acids, and their respective counter-cations.

Additionally or alternatively, in an aspect, the oxidation product of one or more sugars comprises a glucose oxidation product, a gluconic acid oxidation product, a gluconate, or a combination thereof. In such aspects, the glucose oxidation product, gluconic acid oxidation product, or combination thereof may be buffered to a suitable pH. For example, the oxidation product may further comprise one or more suitable buffering agents.

Additionally or alternatively, in one or more aspects, the oxidation product of one or more sugars comprises glucaric acid, gluconic acid, glucuronic acid, glucose oxidation products, gluconic acid oxidation products or a combination thereof. Additionally or alternatively, in one or more aspects, the oxidation product of one or more sugars comprises disaccharides, oxidized disaccharides, uronic acid, aldaric acid or a combination thereof.

Additionally or alternatively, in one or more aspects, the oxidation product of one or more sugars comprises gluconic acid, glucaric acid, glucuronic acid, n-keto-acids, C₂ to Co diacids, or a combination thereof.

Additionally or alternatively, in one or more aspects, the oxidation product of one or more sugars comprises galactonic acid, galactaric acid, an oxidation product comprising predominantly (e.g., greater than about 50 weight percent) galactonic acid and/or galactaric acid with minor component species of n-keto-acids, C₂ to C₆ diacids or a combination thereof. Additionally or alternatively, in one or more aspects, the oxidation product of one or more sugars comprises glutamic acid. Additionally, or alternatively, in one or more aspects, the oxidation product of one or more sugars comprises glucodialdose, 2-ketoglucose or a combination thereof.

Additionally or alternatively, in one or more aspects, the oxidation product of one or more sugars comprises a buffered glucose oxidation product, a buffered gluconic acid oxidation product or combinations thereof. In such aspects, the buffered glucose oxidation product, the buffered gluconic acid oxidation product, or combinations thereof are buffered to a suitable pH. For example, the buffered glucose oxidation product, buffered gluconic acid oxidation product or combination thereof may be buffered to a pH in the range of from about 1 to about 5 where buffering may be carried out using any suitable acid, suitable base, or combination thereof.

Additionally or alternatively, in an aspect, the oxidation product of one or more sugars comprises a glucose oxidation product, a gluconic acid oxidation product, a gluconate, glucaric acid, an oxidized glucuronolactone, a uronic acid oxidation product, or a combination thereof. Alternatively, the oxidation product of one or more sugars comprises a buffered glucose oxidation product, a buffered gluconic acid oxidation product, or a combination thereof. Additionally or alternatively, the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C₂-C₆ diacids, galactonic acid, galactaric acid, glutamic acid, glucodialdose, 2-ketoglucose, glucodiamine, glycoaldehyde, glyoxal, glycine, salts thereof, lactones thereof or combinations thereof.

In one or more aspects, the oxidation product of one or more sugars comprises less than about 5 wt. % maltose, maltotriose, fructose, higher molecular weight polysaccharides, oxidation products thereof or combinations thereof based on the total weight of the oxidation product of one or more sugars.

In one or more aspects, any oxidation product of one or more sugars, or combination thereof as disclosed herein, may further comprise a counter-cation. In various aspects, the counter-cation may comprise a Group 1 alkali metal, a Group 2 alkaline earth metal, a Group 8 metal, Group 11 metal, Group 12 metal or a combination thereof. For example, the counter-cation may comprise silicates, borates, aluminum, calcium, magnesium, ammonium, sodium, potassium, cesium, strontium, zinc, copper, ferric iron and/or ferrous iron, or a combination thereof.

In an aspect, the oxidation product of one or more sugars comprises a metal chelation product commercially available from Solugen, Houston, Texas as BIOCHELATE™, ALTIV™, or ACQUACORE™.

In an aspect, the oxidation product of one or more sugars, acids thereof or salts thereof is present in a BBA of the present disclosure in an amount of from about 0.1 weight percent (wt. %) to about 100 wt. %, additionally or alternatively, from about 1 to about 100 wt. % or alternatively from about 50 to about 100 wt. % based on the total weight of the BBA. Herein all weight percentages are based on the total weight of the composition being described.

In one or more aspects, the BBA comprises a second blowing agent, for example, in addition to the oxidation product of one or more sugars. The second blowing agent may be any material that functions as a blowing agent and is compatible with the other components of the BBA. Nonlimiting examples of a second blowing agent suitable for use in the present disclosure include sodium bicarbonate; a chlorofluorocarbon; an azo-compound such as 1-1′ azobisformamide; an azide compound such as 4,4′-oxybis (benzenesulfonylhydrazide); water; a silicate-based material; a polyisocyanate; carbon dioxide; nitrogen; 1-chloro-1,1-difluoroethane; a hydrofluorocarbon such as 1,1,1,2-tetrafluoroethane, 1,1,2,2-tetrafluoroethane, 1,1-difluoroethane, 1,1,1-trifluoroethane, difluoromethane, pentafluoroethane; a hydrocarbon such as cyclopentane, n-pentane or i-pentane; and combinations thereof. In one or more aspects, the second blowing agent may be characterized as being environmentally unfriendly or subject to one or more regulations such as those imposed by a governmental or regulatory agency to reduce their usage in at least one geographic location. Without wishing to be limited by theory, the presence of the oxidation product of one or more sugars in the BBA may allow for use of a significantly lower amount of the second blowing agent thereby reducing the attendant disadvantages of these compounds described herein.

For example, the second blowing agent may comprise sodium bicarbonate. Sodium bicarbonate is a blowing agent that produces foamed polymers characterized by the formation of a stable gas-melt homogeneous system, cell nucleation, cell growth, and cell stability. In one or more aspects, the BBA comprises sodium bicarbonate, epoxy-modified sodium bicarbonate, acid-modified sodium bicarbonate, or combinations thereof. In one or more aspects, the second blowing agent may be present in the BBA in an amount of from about 0.1 wt. % to about 99.9 wt. %, additionally or alternatively, from about 0.1 to about 50 wt. %, or alternatively from about 10 to about 50 wt. %.

In an aspect, the BBA optionally comprises an additive to minimize discoloration, termed a coloring protectant. The coloring protectant generally refers to any material capable of (i) reducing the discoloration of the polymer when blended with the BBA and foamed and (ii) compatible with the other components of the BBA may be used. In an aspect, the coloring protectant comprises sodium bisulfite. The coloring protectant may be present in the BBA in an amount of from about 0.1 wt. % to about 10 wt. %, additionally or alternatively, from about 0.1 to about 5 wt. %. or alternatively from about 0.1 to about 1 wt. %.

In one or more aspects, the BBA is used to produce a foamed polymer. Nonlimiting examples of polymers that may be foamed with the BBA include ethylene-vinyl acetate, polyethylene, nitrile rubber, copolymers of acrylonitrile and/or butadiene, polylactic acid, polyglycolic acid, polychloroprene foam, polyimide, polypropylene, polystyrene, polyurethane, polyvinyl chloride, polyamide, polyester, polylactic acid and combinations thereof. In an aspect, a BBA of the present disclosure is part of a foamed polymer composition and is present in the composition in an amount ranging from about 0.1 wt. % to about 50 wt. %, additionally or alternatively, from about 0.1 to about 10 wt. %, or alternatively from about 0.1 to about 2 wt. %.

In one or more aspects, a method of producing the foamed polymer comprises preparing a blend of the polymer and BBA using any suitable methodology, such as in a bulk mixer. The method of producing the foamed polymer may further comprise processing the blend using any suitable methodology (e.g., compounded) to provide a thoroughly mixed material and then the thoroughly mixed material may then be subjected to a thermal treatment. For example, the thoroughly mixed material may be heated to temperatures ranging from about 140 °C to about 280 °C, additionally or alternatively, from about 150 °C to about 230 °C or, additionally or alternatively, from about 150 to about 200 °C.

In another aspect, the foamed polymer is produced by polymer extrusion. Polymer extrusion generally refers to a high-volume manufacturing process in which polymer is melted and formed into a continuous profile. The extrusion process involves feeding polymeric material (pellets, granules, flakes, or powders) from a hopper into the barrel of an extruder. The material is gradually melted by the mechanical energy generated by turning screws and by heaters arranged along the barrel. The molten polymer may then be forced into a die, which shapes the polymer into a shape that hardens during cooling. As will be understood by one of ordinary skill in the art, the specific type of extrusion and conditions (e.g., temperatures) at which the foamed polymer composition is produced will depend on the type of polymer being foamed.

In an aspect, polymer extrusion is carried out by heating the polymer in an extruder to produce a polymer melt and contacting the melt with a BBA of the type disclosed herein at a temperature ranging from about 160 °C to about 280 °C, additionally or alternatively, from about 180 °C to about 230 °C, additionally or alternatively from about 180 °C to about 200 °C resulting in a foamed polymer composition. In an aspect, the foamed polymer composition may then pass through a relaxation zone, generally located in the last stage of extruder prior to being introduced to the die, in which it is cooled.

In one or more aspects, a foamed polymer composition comprising a BBA of the type disclosed herein is formed into a film. For example, a foamed polymer composition comprising a LDPE and a BBA may be formed into a film characterized by a tensile strength at break ranging from about 200 psi to about 2000 psi, additionally or alternatively, from about 400 psi to about 1600 psi or alternatively from about 400 psi to about 1200 psi as determined in accordance with ASTM D882. In such aspects, the film may be characterized by a percentage elongation ranging from about 1 to about 400, additionally or alternatively, from about 10 to about 300 or alternatively from about 50 to about 300 as determined in accordance with ASTM D882.

In an aspect, a BBA of the type disclosed herein evolves gas when thermally treated and forms pores within a material such as a polymer. In various aspects, the pores may be open-cell, closed-cell, or combinations, for example, in various proportions, thereof.

The foamed polymers of the present disclosure may be characterized by resistance to charring and as a result the BBA may function as a fire-retardant material. For instance, the BBA disclosed herein may be particularly useful and/or advantageously employed as a flame retardant. Flame retardants (FR) are chemical compounds added to or otherwise incorporated into plastic compounds to provide varying degrees of flammability protection. Conventional flame retardants are based on materials such as halogen-containing compounds or organophosphorus-containing compounds. However, environmental concerns and scrap disposal issues make the BBAs of this disclosure particularly attractive alternatives to or additives with flame retardants that can reduce the amount of halogenated flame retardants utilized.

In one or more aspects, a BBA of this disclosure is used in conjunction with conventional flame retardants to provide flammability protection. Any conventional flame retardant compatible with the other components of the composition may be used. Nonlimiting examples of conventional flame retardants that may be used with a BBA of the disclosure includes chlorendic acid derivatives and chlorinated paraffins; organobromines such as decabromodiphenyl ether (decaBDE), decabromodiphenyl ethane, polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). triphenyl phosphate (TPP), resorcinol bis(diphenylphosphate) (RDP), bisphenol A, diphenyl phosphate (BADP), tricresyl phosphate (TCP); phosphonates, dimethyl methylphosphonate (DMMP); phosphinates such as aluminum diethyl phosphinate, tris(2,3-dibromopropyl) phosphate (brominated tris), tris(1,3-dichloro-2-propyl)phosphate (chlorinated tris or TDCPP), tetrakis(2-chlorethyl)dichloroisopentyldiphosphate (V6) and combinations thereof. Such formulations comprising a BBA and a conventional flame retardant may have the ratio of BBA to conventional flame retardant range from about 100:1 to about 1:100, additionally or alternatively, from about 10:90 to about 90:10 or alternatively from about 20:80 to about 80:20.

BBAs of the type disclosed herein, for example sodium glucarate or gluconate salts derived from sugars can be used as blowing agent to make foamed polymers. In an aspect, the BBA is used in combination with other blowing agents for a synergistic effect. BBAs of the present disclosure can also be used a flame retardant additive, and hence they can act as multi-functional polymeric additives.

### ADDITIONAL DISCLOSURE

The following enumerated aspects of the present disclosures are provided as non-limiting examples.

A first aspect which is a blowing agent composition comprising an oxidation product of one or more sugars and an optional second blowing agent.

A second aspect which is the composition of the first aspect wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

A third aspect which is the composition of any of the first through second aspects wherein the oxidation product of one or more sugars comprises less than about 5 wt. % maltose, maltotriose, fructose, higher molecular weight polysaccharides, oxidation products thereof or combinations thereof based on the total weight of the oxidation product of one or more sugars.

A fourth aspect which is the composition of any of the first through third aspects wherein the oxidation product of one or more sugars further comprises a counter cation.

A fifth aspect which is the composition of the fourth aspect wherein the counter cation comprises a Group 1 alkali metal, a Group 2 alkaline earth metal, a Group 8 metal, a Group 11 metal, a Group 12 metal or a combination thereof.

A sixth aspect which is the composition of the fourth aspect wherein the counter cation comprises silicates, borates, aluminum, calcium, magnesium, ammonium, sodium, potassium, cesium, strontium, zinc, copper, ferric iron, ferrous iron or a combination thereof.

A seventh aspect which is a foamed polymer composition comprising a polymer and a blowing agent comprising an oxidation product of one or more sugars and an optional second blowing agent.

An eighth aspect which is the composition of the seventh aspect wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

A ninth aspect which is the composition of any of the seventh through eighth aspects wherein the oxidation product of one or more sugars comprises less than about 5 wt. % maltose, maltotriose, fructose, higher molecular weight polysaccharides, oxidation products thereof or combinations thereof based on the total weight of the oxidation product of one or more sugars.

A tenth aspect which is the composition of any of the seventh through ninth aspects wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.

An eleventh aspect which is the composition of any of the seventh through tenth aspects wherein the polymer comprises low density polyethylene (LDPE) polymer, high melt strength polypropylene (HMSPP or HPP) polymer, ethylene vinyl acetate (EVA) polymer, general purpose polystyrene (GPPS) polymer or combinations thereof.

A twelfth aspect which is the composition of any of the seventh through eleventh aspects further comprising a color protectant.

A thirteenth aspect which is the composition of any of the seventh through twelfth aspects wherein the second blowing agent comprises chlorofluorocarbons (CFC's), azo-compounds, azide compounds, water, silicate-based materials, polyisocyanates, carbon dioxide, nitrogen, 1-chloro-1,1-difluoroethane; hydrofluorocarbons such as 1,1,1,2-tetrafluoroethane, 1,1,2,2-tetrafluoroethane (134), 1,1-difluoroethane, 1,1,1-trifluoroethane, difluoromethane, pentafluoroethane, hydrocarbons or a combination thereof.

A fourteenth aspect which is a method comprising forming a mixture comprising a blowing agent, an optional second blowing agent and a polymer and extruding the mixture to form a foamed polymer wherein the blowing agent comprises an oxidation product of one or more sugars.

A fifteenth aspect which is the method of the fourteenth aspect wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

A sixteenth aspect which is the method of any of the fourteenth through fifteenth aspects wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.

A seventeenth aspect which is the method of any of the fourteenth through sixteenth aspects further comprising forming the foamed polymer into a film.

An eighteenth aspect which is the method of the seventeenth aspect wherein the film has a tensile strength at break of from about 200 psi to about 2000 psi as determined in accordance with ASTM D882.

A nineteenth aspect which is the method of any of the seventeenth through eighteenth aspects wherein the film has a percentage elongation of from about 1% to about 400% as determined in accordance with ASTM D882.

A twentieth aspect which is a method of making a foamed polymeric material, the method comprising preparing a blend of a polymeric material and a blowing agent, wherein the blowing agent comprises the oxidation product of one or more sugars, and extruding the polymeric material and the blowing agent at a temperature ranging from about 140 °C to about 280 °C.

A twenty-first aspect which is the method of the twentieth aspect wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

A twenty-second aspect which is the method of any of the twentieth through twenty-first aspects wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

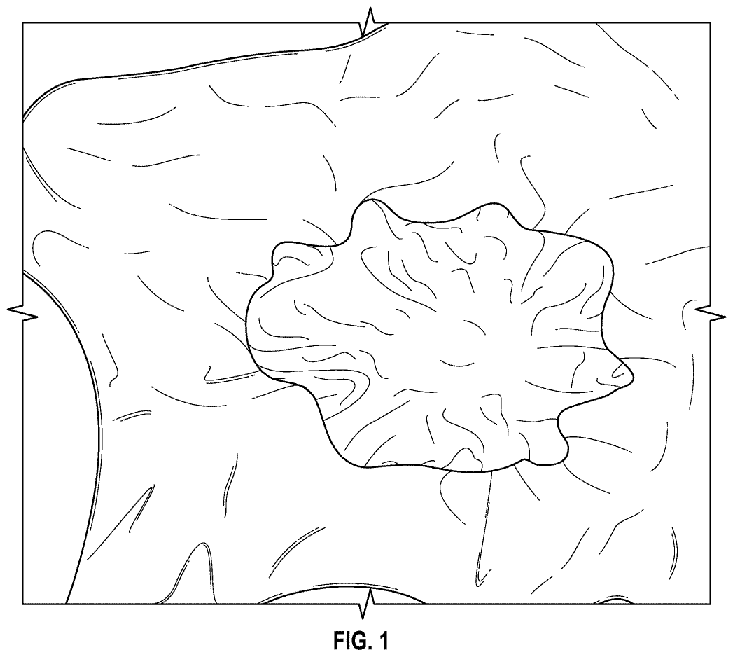

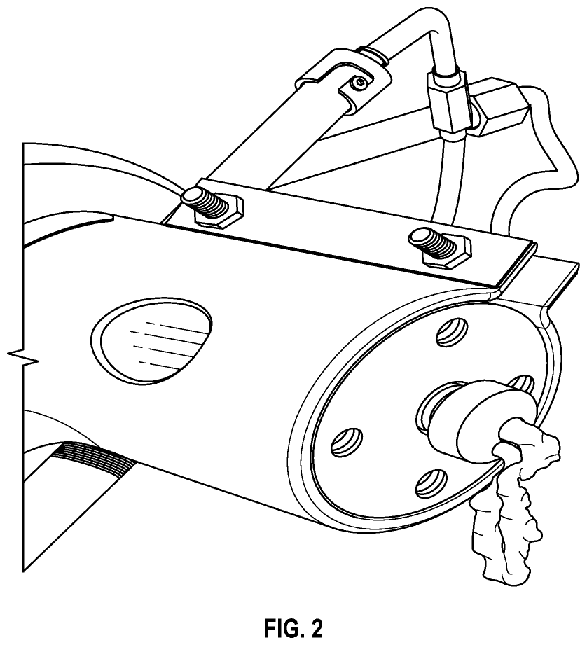

The foaming ability of BBAs of the type disclosed herein was investigated. Specifically, a sample of potassium glucarate was observed to foam when heated to a temperature of 190 °C for five minutes. As shown in FIG. 1, the sample both charred and developed a porous structure indicating that potassium glucarate alone was able to generate sufficient gas when heated to create a porous structure. A sample of polylactic acid was compounded with 10 wt. % calcium glucarate and foamed in a single screw extruder. FIG. 2 shows the extrudate is a foamed polymer.

### Example 2

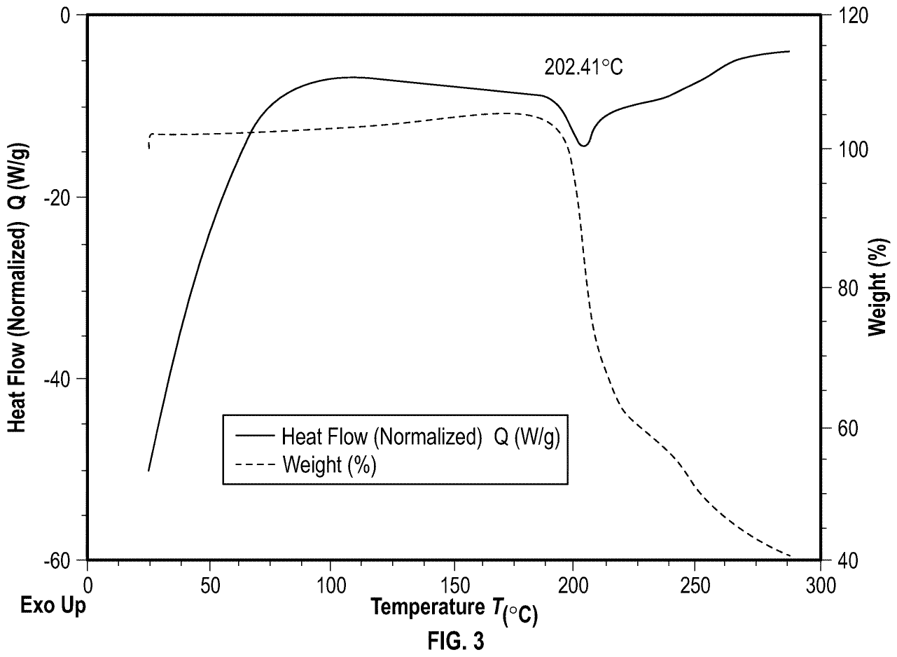

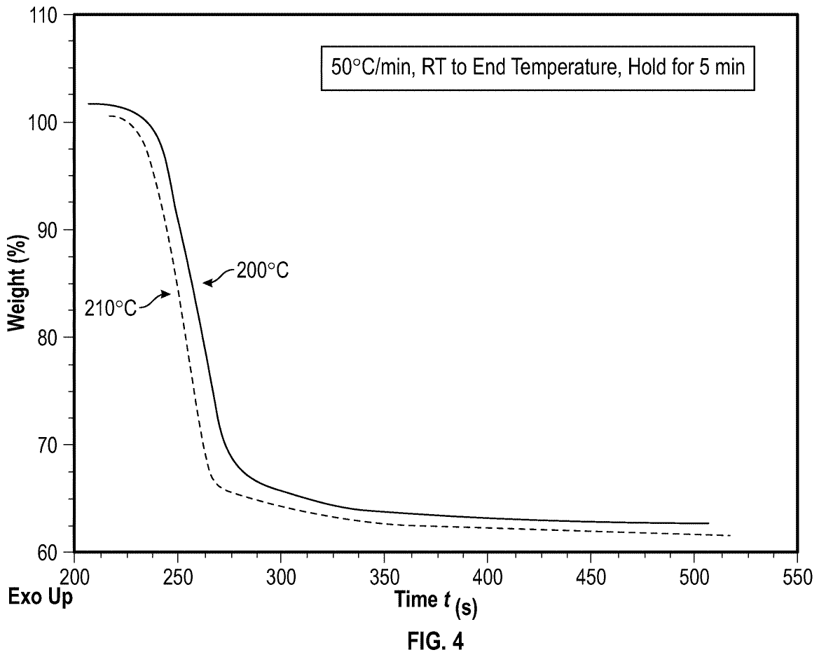

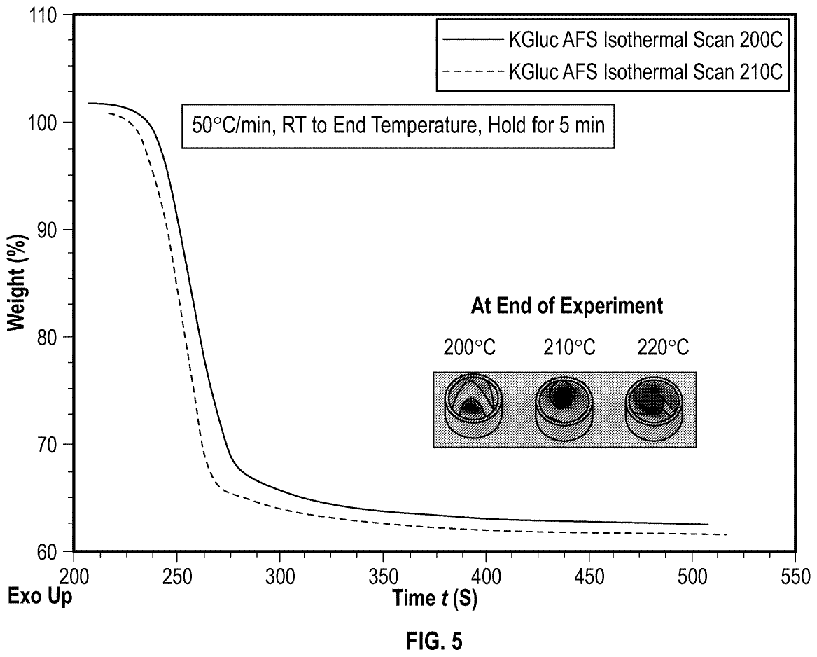

A 2.4 mg sample of potassium glucarate was subjected to thermal analysis. The sample formed a powder that was almost black at the end of the thermal treatment and foamed to give a volume that was approximately 10× the initial volume. The sample was found to have a decomposition temperature of about 202 °C and lost about 40% of the sample mass by the end of the thermal treatment. The results are presented in FIGS. 3 and 4. The experiment was repeated using less than 1 mg sample of potassium glucarate. The sample during thermal treatment foamed too much at 220 °C (increase in mass due to over-deflection of sensor) and showed about 40% mass loss at the end of the treatment. The results are shown in FIG. 5.

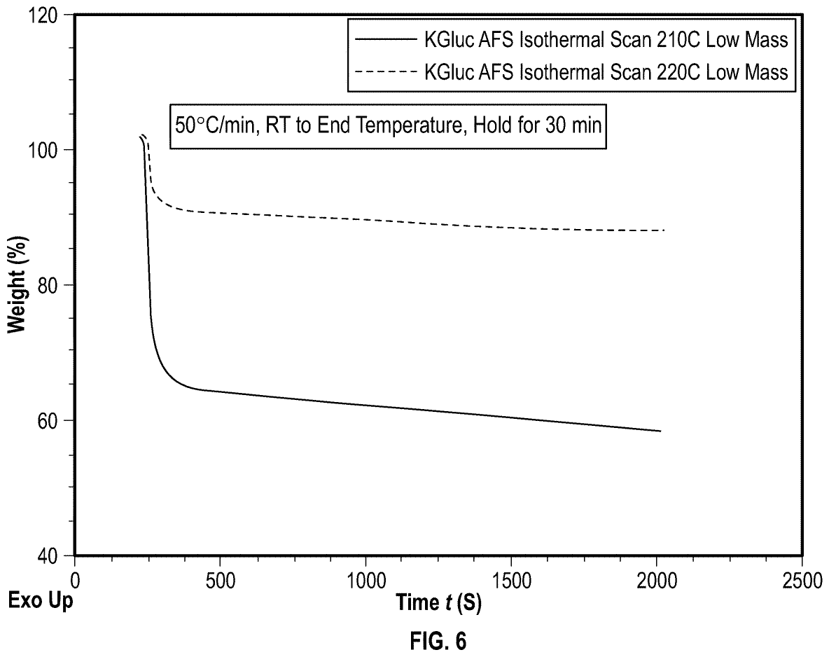

A third sample having approximately 0.5 mg of potassium glucarate was subjected to thermal treatment. The mass of the third sample was found to be too low at 200 °C (<0.5 mg) and the mass loss was not accurately recorded. The mass losses were estimated to be 40% at 210 °C, and 10% at 220 °C. The results are presented in FIG. 6.

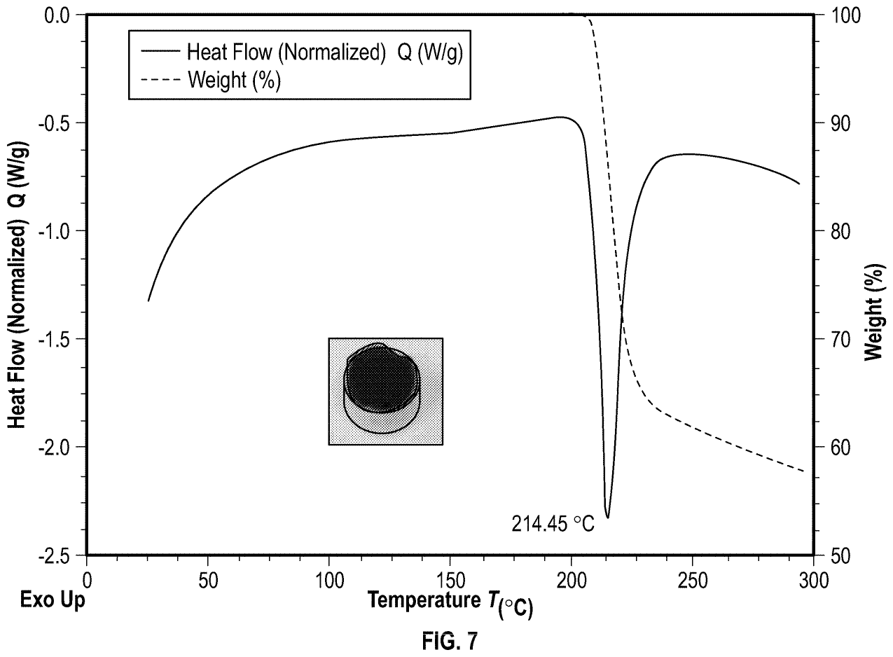

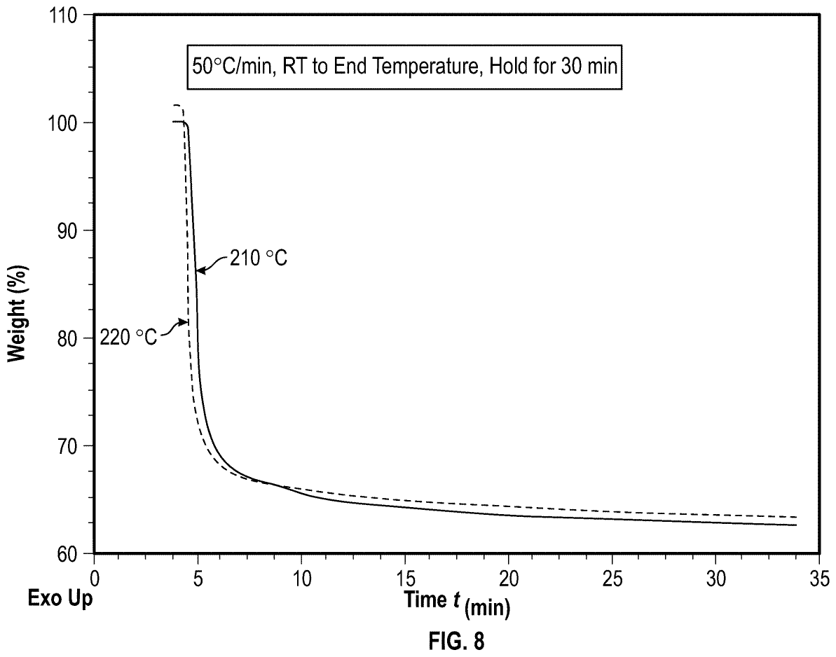

Similar experiments were carried out for a sample of sodium gluconate which during thermal treatment foamed to a volume greater than 10× the initial volume with a decomposition temperature of about 215 °C and a mass loss of approximately 38%. The results are shown in FIGS. 7 and 8.

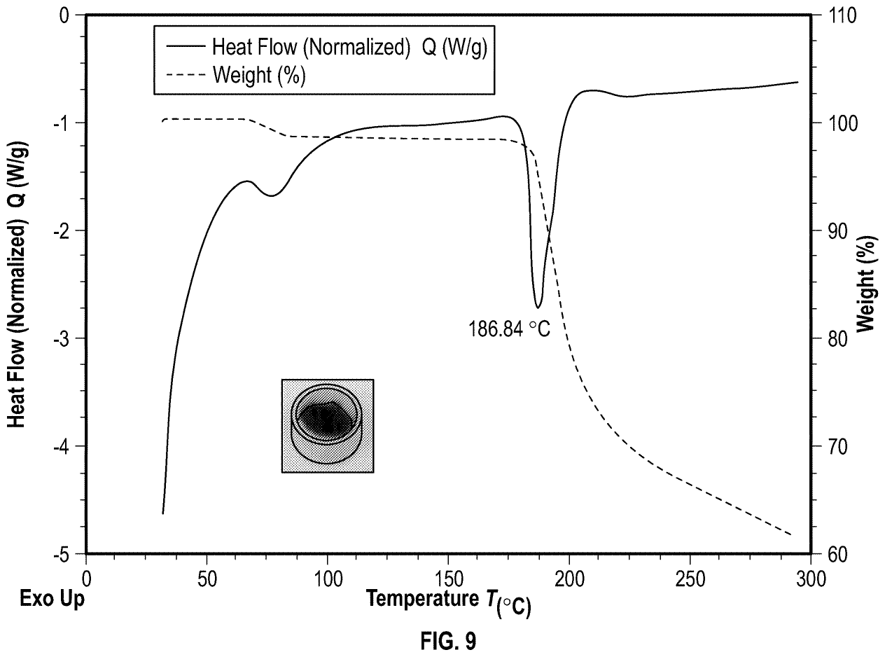

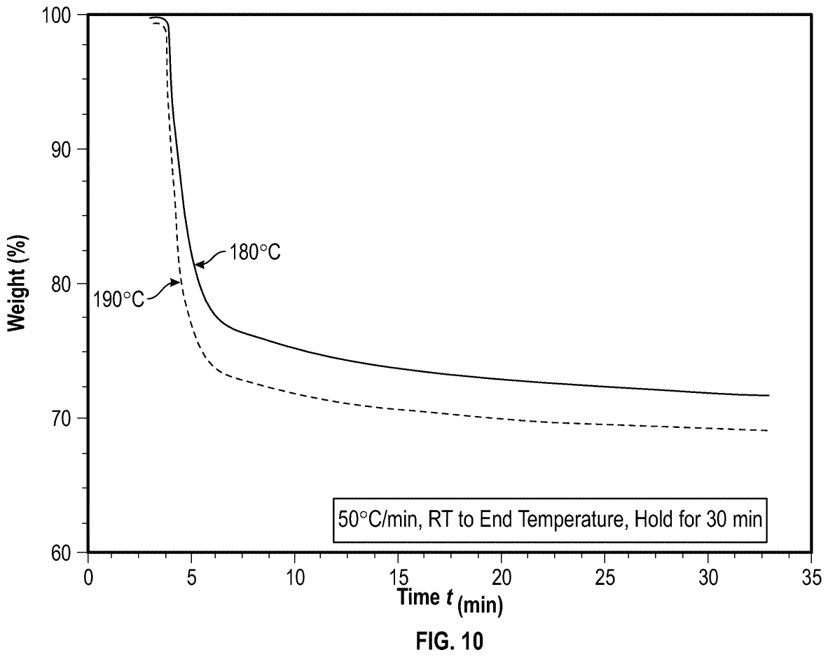

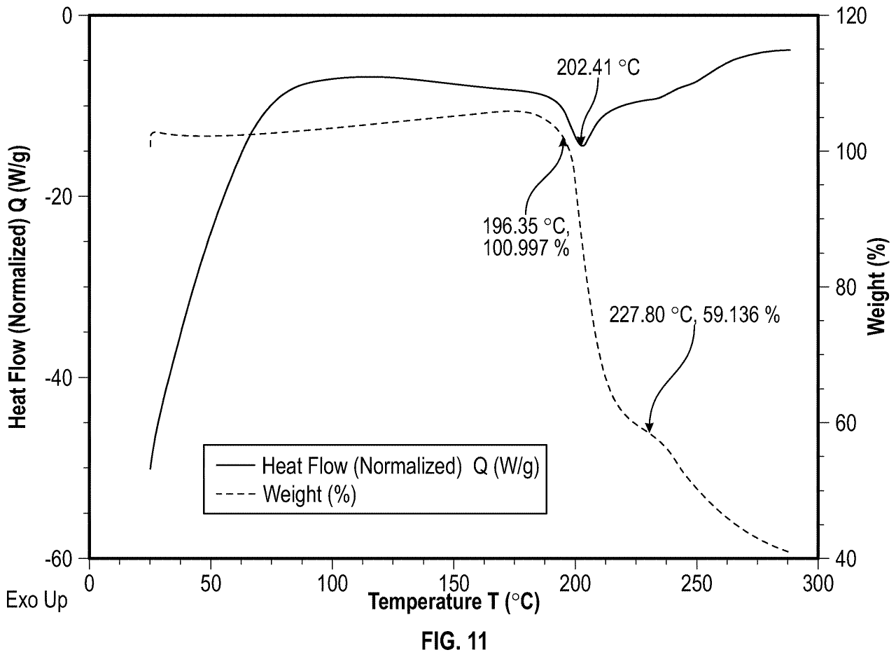

Similar experiments were carried out for (i) a sample of potassium gluconate which during thermal treatment foamed to a volume approximately 5× the initial volume with a decomposition temperature of about 187 °C with a mass loss of approximately 30% and (ii) a sample of calcium glucarate which showed three decomposition temperatures of 105 °C, 157 °C and 225 °C with a mass loss of between 10 and 20%. The results are shown for sample (i) in FIGS. 9 and 10 and for sample (ii) in FIG. 11.

### Example 3

The foam density of various polymers containing a BBA of the type disclosed herein was investigated. For these experiments, a masterbatch (MB) was prepared for each polymer type and the MB subjected to extrusion with a 20 mm/30:1 L/D single screw with a mixing section, air cooled strands, ⅛″ rod die. L/D refers to ratio of the length of the screws to the screw diameter.

With reference to Table 1, samples contained low density polyethylene (LDPE) polymer, high melt strength polypropylene (HMSPP or HPP) polymer, ethylene vinyl acetate (EVA) polymer, or general purpose polystyrene (GPPS) polymer. HMSPP samples were prepared using the polymer in powder form while all remaining samples had polymers that were in pellet form. The LDPE and HSMPP polymers had a melt flow rate (MFR) of 12 g/10 min and the MFR of EVA polymer was 2 g/10 min. The MFR was determined in accordance with ASTM D238.

Each of the samples contained the components indicated in Table 1. As indicated each sample contained 460 grams of the sample polymer. Samples 1-3 and 7-12 contained 1.5 grams of the wetting agent calcium stearate which functions as a lubricant. Samples 3, 6, 9 and 12 contained 40 grams of PLUSTALC H3O functional extender commercially available from ELEMENTIS. PLUSTALC H30 is a hydrated magnesium silicate with chemical formula of Mg₃Si₄O₁₀(OH)₂ which functions as nucleating agent.

The specific reaction conditions used for sample extrusion along with the physical characteristics of each sample are also presented in Table 1. The sample colors were characterized as natural (1); light (2); dark brown (3); dirty (4); cream (5) and pink (6).

TABLE 1

| | Sample No. | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| | LDPE | LDPE | LDPE | HMSPP | HMSPP | HMSPP | GPPS | GPPS | GPPS | EVA | EVA | EVA |
| Wetting | 1.5 gms | 1.5 gms | 1.5 gms | 0 | 0 | 0 | 1.5 gms | 1.5 gms | 1.5 gms | 1.5 gms | 1.5 gms | 1.5 gms |
| agent | | | | | | | | | | | | |
| Sod. | 40 gms | | | 40 gms | | | 40 gms | | | 40 gms | | |
| Gluconate | | | | | | | | | | | | |
| Potassium | | 40 gms | | | 40 gms | | | 40 gms | | | 40 gms | |
| Glucarate | | | | | | | | | | | | |
| PlusTalc | | | 40 gms | | | 40 gms | | | 40 gms | | | 40 gms |
| H30 | | | | | | | | | | | | |
| Z1 C | 139 | 139 | 162 | 170 | 156 | 162 | 150 | 164 | 162 | 140 | 140 | 160 |
| Z2 C | 149 | 140 | 159 | 163 | 166 | 172 | 150 | 161 | 161 | 141 | 145 | 160 |
| Z3 C | 156 | 145 | 159 | 150 | 151 | 185 | 160 | 150 | 145 | 147 | 152 | 161 |
| Tₘ, C | 137 | 139 | 159 | 153 | 157 | 182 | 155 | 158 | 156 | 139 | 135 | 160 |
| RPM | 50 | 50 | 50 | 40 | 50 | 40 | 50 | 50 | 40 | 50 | 50 | 50 |
| Torque | 29.2 | | | 43.5 | 25.5 | 24.8 | | | | 38.3 | 42.2 | 32.8 |
| Nm | | | | | | | | | | | | |
| Pressure | 15 | | 20 | 15 | 8 | 3 | | 21 | 18 | 29 | 30 | 22 |
| Bars | | | | | | | | | | | | |
| Color | 1 | 2 | 2 | 3 | 4 | 5 | 3 | 2 | 5 | 2 | 2 | 2 |
| % residue | 3.1 | 3 | 7.2 | 7.7 | 5.5 | 8.5 | 3.4 | 4.8 | 7.8 | 3.2 | 4.4 | 7.7 |
| 230 °C | | | | | | | | | | | | |
| % residue | | | | 5.95 | 4.38 | | | | | | | |
| 285 °C | | | | | | | | | | | | |

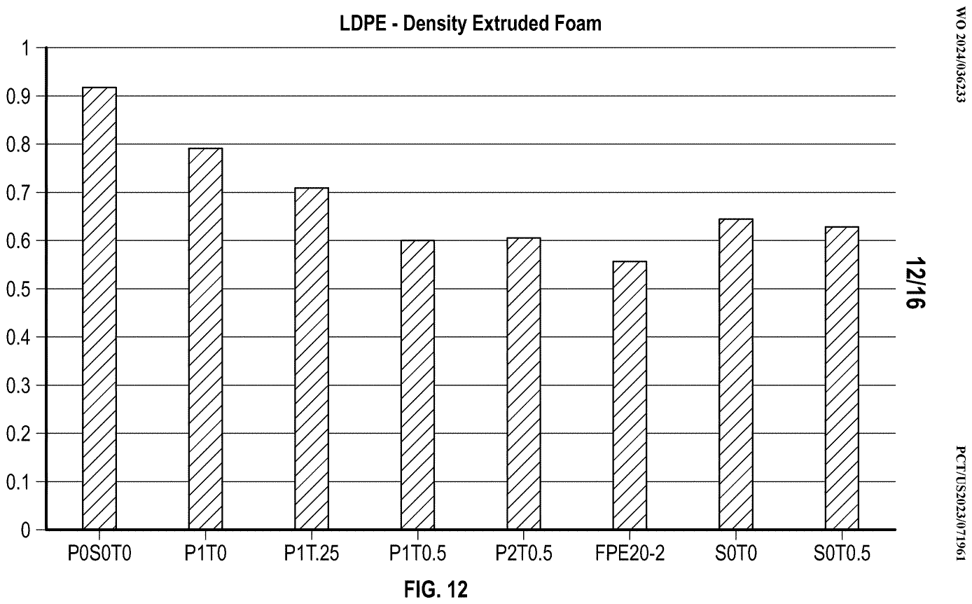

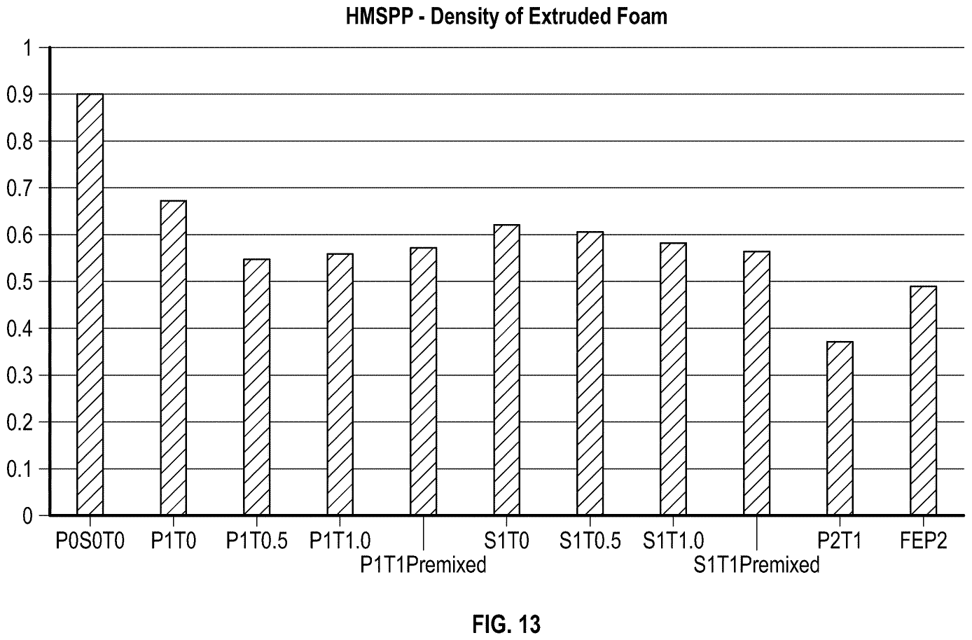

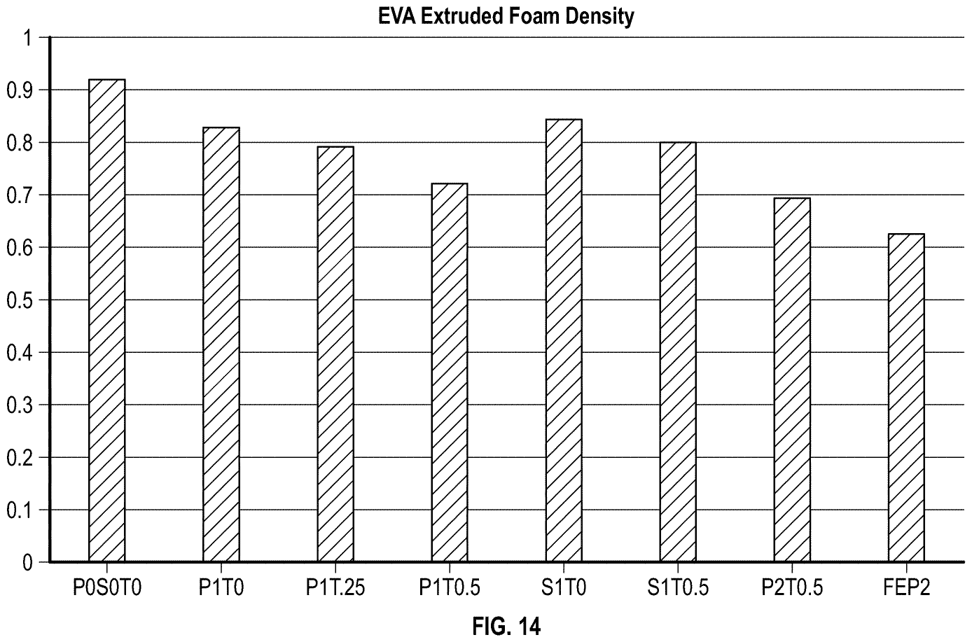

The extruded foam density of various samples of low density polyethylene (LDPE), high melt strength polypropylene (HMSPP), and ethylene vinyl acetate (EVA) polymers were determined and are presented in FIGS. 12, 13 and 14, respectively.

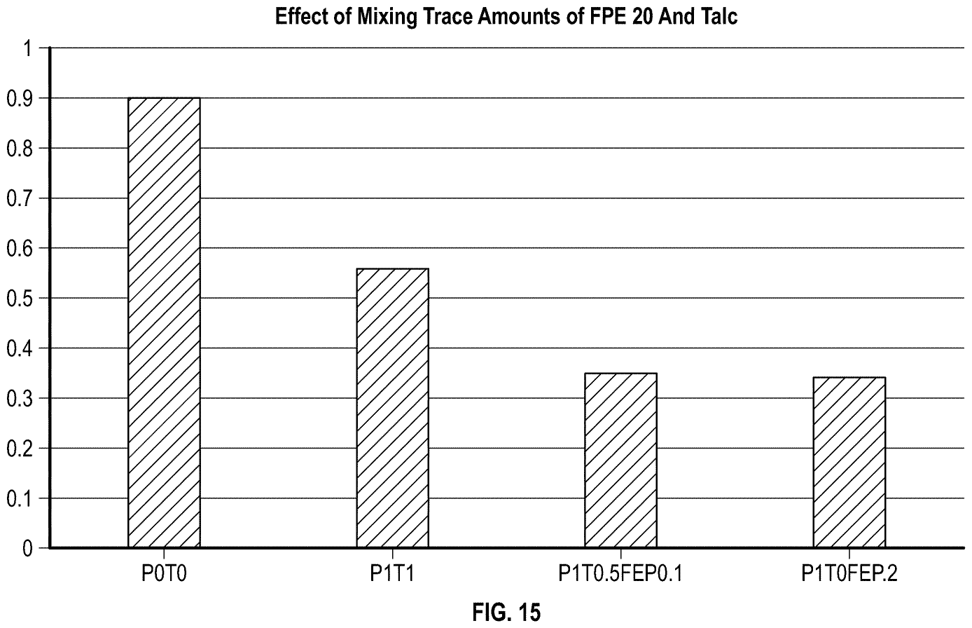

The effect of the addition of SAFOAM FPE20 exothermic foaming agent which is a chemical blowing agent commercially available from Reedy Chemicals and PLUSTALC H3O on the extruded foam density of a composition having a HMSPP and a BBA was investigated and the results are presented in FIG. 15. In FIGS. 12-16, each bar is labelled with P which indicates the amount of potassium glucarate, S which indicates the amount of sodium gluconate, T which indicates the amount of talc, and FEP refers to the amount of SAFOAM FEP20 present. All amounts are in terms of weight percent based on the total weight of the sample.

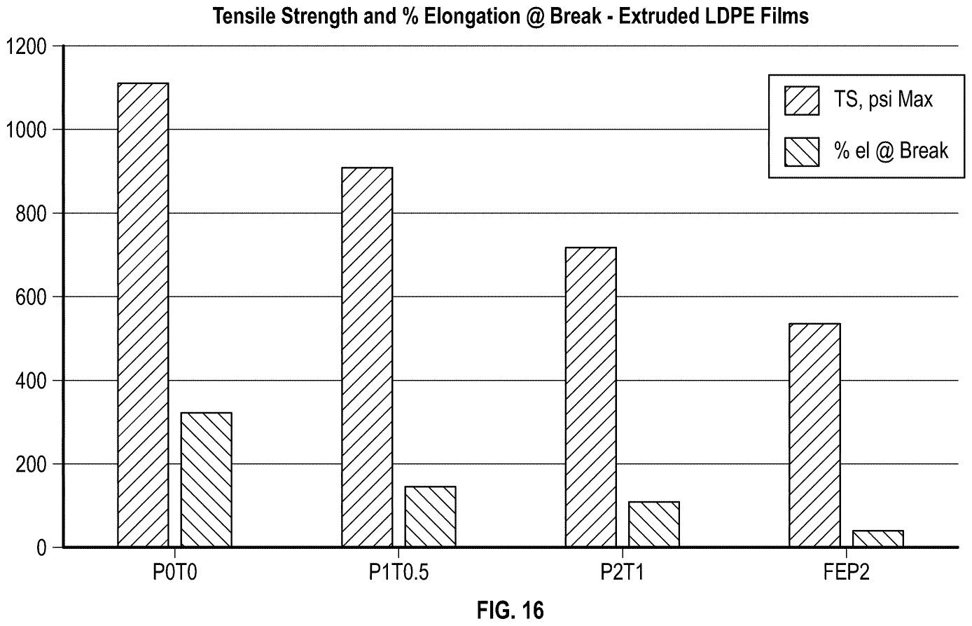

An LDPE foamed with a BBA of the type disclosed herein was prepared as a film. Mechanical properties of the film, specifically tensile strength and elongation at break were evaluated and the results are presented in FIG. 16.

A summary of the results obtained for each of the polymer samples investigated is presented in Table 2. The extruder die was a 4′ L/D with the exception of samples 22-24 which were extruded using a 1′ L/D. Changes in the die size are due to the need to adjust the pressure at the exit of the extruder for appropriate sample preparation.

Foamed polymer samples were formed into films of the thickness indicated in Table 2. The tensile strength at break and percentage elongation at break were determined for the film specimens. Tensile strength refers to the maximum stress a plastic specimen can withstand while being stretched before breaking while the percent elongation refers to the percentage that a material stretches beyond its original length before it breaks. Both the tensile strength and the percent elongation was determined in accordance with ASTM D882.

TABLE 2

| | | | | | PLUSTALC | SAFOAM | | | | Tensile | |
|---|---|---|---|---|---|---|---|---|---|---|---|
| | | | KGlu | NaGluco | H30 | FPE20 | | Film | | Strength at | |
| | | | MB-10 | MB-10 | MB-10 | MB-20 | | Thickness | Density | break | % elongation |
| Exp | Resin | Resin | % | % | % | % | RPM | mm | g/cc | psi | at break |
| 1 | LDPE | 100 | 0 | 0 | 0 | 0 | 20 | 0.34, 0.34 | 0.917 | 1110 | >320 |
| 2 | LDPE | 90 | 10 | 0 | 0 | 0 | 20 | 0.46, 0.60 | 0.711 | | |
| 3 | LDPE | 85 | 10 | 0 | 5 | 0 | 20 | 0.48, 0.50 | 0.6 | 909 | 145 |
| 4 | LDPE | 87.5 | 10 | 0 | 2.5 | 0 | 20 | 0.53, 0.50 | 0.708 | | |
| 5 | LDPE | 75 | 20 | 0 | 5 | 0 | 40 | 0.35. 0.39 | 0.605 | 717 | 110 |
| 6 | LDPE | 90 | 0 | 0 | 0 | 10 | 20 | 0.73, 0.68 | 0.557 | 535 | 42 |
| 9 | LDPE | 90 | 0 | 10 | 0 | 0 | 20 | 0.62, 0.57 | 0.645 | | |
| 10 | LDPE | 85 | 0 | 10 | 5 | 0 | 20 | 0.52. 0.52 | 0.627 | | |
| 11 | HMSPP | 100 | 0 | 0 | 0 | 0 | 20 | .10, .10 | 0.901 | 3883 | 12 |
| 12 | HMSPP | 90 | 10 | 0 | 0 | 0 | 20 | 0.45, 0.45 | 0.673 | | |
| 13 | HMSPP | 85 | 10 | 0 | 5 | 0 | 20 | 0.42, 0.46 | 0.547 | | |
| 14 | HMSPP | 80 | 10 | 0 | 10 | 0 | 20 | 0.62, 0.64 | 0.559 | 2834 | 6 |
| 15 | HMSPP | 90 | 0 | 10 | 0 | 0 | 20 | 0.37, 0.44 | 0.62 | | |
| 16 | HMSPP | 85 | 0 | 10 | 5 | 0 | 20 | 0.32, 0.31 | 0.608 | | |
| 17 | HMSPP | 80 | 0 | 10 | 10 | 0 | 20 | 0.44, 0.45 | 0.582 | | |
| 18 | HMSPP | 90 | 10 | 0 | 10/prc | 0 | 20 | 0.47, 0.45 | 0.56 | 2654 | 7.7 |
| 19 | HMSPP | 90 | 0 | 10 | 10/pre | 0 | 20 | 0.42, 0.45 | 0.573 | | |
| 20 | HMSPP | 90 | 0 | 0 | 0 | 10 | 20 | 0.37, 0.32 | 0.491 | 1640 | 5.53 |
| 21 | HMSPP | 75 | 20 | 0 | 5 | 0 | 40 | 0.56, 0.57 | | 2509 | 3.88 |
| 22 | HMSPP | 90 | 9.5 | 0 | 0 | 0.5 | 10 | 2.85, 2.89 | 0.347 | | |
| 23 | HMSPP | 90 | 9 | 0 | 0 | 1 | 10 | 2.12, 2.40 | 0.341 | | |
| 24 | HMSPP | 90 | 0 | 0 | 0 | 10 | 10 | 2.55, 2.60 | 0.355 | | |
| 25 | EVA | 100 | 0 | 0 | 0 | 0 | 20 | 0.20, 0.19 | 0.92 | | |
| 26 | EVA | 90 | 10 | 0 | 0 | 0 | 20 | 0.66, 0.73 | 0.83 | | |
| 27 | EVA | 87.5 | 10 | 0 | 2.5 | 0 | 20 | 0.61, 0.58 | 0.793 | | |
| 28 | EVA | 85 | 10 | 0 | 5 | 0 | 20 | 0.57, 0.54 | 0.723 | | |
| 29 | EVA | 75 | 20 | 0 | 5 | 0 | 40 | 0.78. 0.80 | 0.695 | | |
| 30 | EVA | 90 | 0 | 10 | 0 | 0 | 20 | 0.54, 0.52 | 0.843 | | |
| 31 | EVA | 87.5 | 0 | 10 | 2.5 | 0 | 20 | 0.55, 0.56 | 0.824 | | |
| 32 | EVA | 85 | | 10 | 5 | 0 | 20 | .57, 0.58 | 0.799 | | |
| 33 | EVA | 90 | 0 | 0 | 0 | 10 | 20 | .69, 0.68 | 0.626 | | |
| 34 | GPPS | 90 | 0 | 10 | 0 | 0 | 20 | 0.71, 0.65 | 0.78 | | |
| 35 | GPPS | 100 | 0 | 0 | 0 | 0 | 20 | | 1.13 | | |

KGlu = potassium glucarate
NaGluco = sodium gluconate

BBAs of the type disclosed herein advantageously provide a polymeric compositions with an acceptable density reduction with a decreased reduction in tensile strength compared to incumbent.

While aspects of the presently disclosed subject matter have been shown and described, modifications thereof can be made by one skilled in the art without departing from the spirit and teachings of the subject matter. The aspects described herein are exemplary only, and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A blowing agent composition comprising an oxidation product of one or more sugars and an optional second blowing agent.

2. The composition of claim 1, wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

3. The composition of claim 1, wherein the oxidation product of one or more sugars comprises less than about 5 wt. % maltose, maltotriose, fructose, higher molecular weight polysaccharides, oxidation products thereof or combinations thereof based on the total weight of the oxidation product of one or more sugars.

4. The composition of claim 1, wherein the oxidation product of one or more sugars further comprises a counter cation.

5. The composition of claim 4, wherein the counter cation comprises a Group 1 alkali metal, a Group 2 alkaline earth metal, a Group 8 metal, a Group 11 metal, a Group 12 metal or a combination thereof.

6. The composition of claim 4, wherein the counter cation comprises silicates, borates, aluminum, calcium, magnesium, ammonium, sodium, potassium, cesium, strontium, zinc, copper, ferric iron, ferrous iron or a combination thereof.

7. A foamed polymer composition comprising a polymer and a blowing agent comprising an oxidation product of one or more sugars and an optional second blowing agent.

8. The composition of claim 7, wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

9. The composition of claim 7, wherein the oxidation product of one or more sugars comprises less than about 5 wt. % maltose, maltotriose, fructose, higher molecular weight polysaccharides, oxidation products thereof or combinations thereof based on the total weight of the oxidation product of one or more sugars.

10. The composition of claim 7, wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.

11. The composition of claim 7, wherein the polymer comprises low density polyethylene (LDPE) polymer, high melt strength polypropylene (HMSPP or HPP) polymer, ethylene vinyl acetate (EVA) polymer, general purpose polystyrene (GPPS) polymer or combinations thereof.

12. The composition of claim 7, further comprising a color protectant.

13. The composition of claim 7, wherein the second blowing agent comprises chlorofluorocarbons (CFC's), azo-compounds, azide compounds, water, silicate-based materials, polyisocyanates, carbon dioxide, nitrogen, 1-chloro-1,1-difluoroethane; hydrofluorocarbons such as 1,1,1,2-tetrafluoroethane, 1,1,2,2-tetrafluoroethane (134), 1,1-difluoroethane, 1,1,1-trifluoroethane, difluoromethane, pentafluoroethane, hydrocarbons or combinations thereof.

14. A method comprising forming a mixture comprising a blowing agent, an optional second blowing agent and a polymer and extruding the mixture to form a foamed polymer wherein the blowing agent comprises an oxidation product of one or more sugars.

15. The method of claim 14, wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

16. The method of claim 14, wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.

17. The method of claim 14, further comprising forming the foamed polymer into a film.

18. The method of claim 17, wherein the film has a tensile strength at break of from about 200 psi to about 2000 psi as determined in accordance with ASTM D882.

19. The method of claim 17, wherein the film has a percentage elongation of from about 1% to about 400% as determined in accordance with ASTM D882.

20. A method of making a foamed polymeric material comprising:
preparing a blend of a polymeric material and a blowing agent, wherein the blowing agent comprises the oxidation product of one or more sugars; and
extruding the polymeric material and the blowing agent at a temperature ranging from about 140 °C to about 280 °C.

21. The method of claim 20, wherein the oxidation product of one or more sugars comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, glycine, salts thereof, lactones thereof or combinations thereof.

22. The method of claim 20, wherein the polymer is selected from the group comprising ethylene-vinyl acetate copolymer, polyethylene, nitrile rubber, copolymers of acrylonitrile and butadiene, polylactic acid, polyglycolic acid, polychloroprene, polyimide, polypropylene, polystyrene, polyurethane, polyvinyl chloride, polyester, polylactic acid and combinations thereof.
